(19) United States
(12) Patent Application Publication
(10) Pub. No.: US 2013/0030999 A1
(43) Pub. Date: Jan. 31, 2013

(54) METHOD AND APPARATUS FOR SELECTING DENOMINATIONS IN AN AUTOMATED TELLER MACHINE

(71) Applicants: Bo Ik CHANG, Seongnam-si (KR); Hae Jung YIM, Seoul (KR); Yoo Mee MIN, Seongnam-si (KR)

(72) Inventors: Bo Ik CHANG, Seongnam-si (KR); Hae Jung YIM, Seoul (KR); Yoo Mee MIN, Seongnam-si (KR)

(73) Assignee: NAUTILUS HYOSUNG INC., Seoul (KR)

(21) Appl. No.: 13/339,147

(22) Filed: Dec. 28, 2011

(30) Foreign Application Priority Data
Jul. 27, 2011 (KR) 10-2011-0074513

(51) Int. Cl. G06Q 40/02

(52) U.S. Cl. 705/43

(57) ABSTRACT

A method of selecting denominations in an automated teller machine (ATM) may be provided. The method may include receiving a request for withdrawal from a user, displaying, on a touch screen, symbols corresponding to a plurality of denominations including a first denomination and a second denomination that constitute a withdrawal amount of the user, and a number of banknotes of each of the plurality of denominations, in response to the reception of the request, sensing a touch-based movement gesture from the first denomination to the second denomination, updating a number of banknotes of the first denomination and a number of banknotes of the second denomination, in response to the sensing of the touch-based movement gesture, and displaying, on the touch screen, the updated number of banknotes of the first denomination and the updated number of banknotes of the second denomination along with the symbols corresponding to the plurality of denominations.

### CROSS-REFERENCE TO RELATED APPLICATION

This application claims the benefit of Korean Patent Application No. 10-2011-0074513, filed on Jul. 27, 2011, which is incorporated herein by reference in its entirety.

### BACKGROUND

1. Field of the Invention

The present invention relates to a method and apparatus for selecting denominations of banknotes in an automated teller machine (ATM).

2. Description of the Related Art

An automated teller machine (ATM) may promptly provide most financial services, excluding consultations, without assistance from a teller, irrespective of a time and a place. However, since the ATM is operated without a teller, users may have a difficulty in selecting varied denominations constituting a withdrawal amount, when compared to a real bank.

### SUMMARY

An aspect of the present invention provides a method and apparatus for selecting denominations in an automated teller machine (ATM) that enables a user to variously select denominations constituting a withdrawal amount to be withdrawn by the user.

According to an aspect of the present invention, there is provided a method of selecting denominations in an automated teller machine (ATM), the method including receiving a request for withdrawal from a user, displaying, on a touch screen, symbols corresponding to a plurality of denominations including a first denomination and a second denomination that constitutes a withdrawal amount of the user, and a number of banknotes of each of the plurality of denominations, in response to the reception of the request, sensing a touch-based movement gesture from the first denomination to the second denomination, updating a number of banknotes of the first denomination and a number of banknotes of the second denomination, in response to the sensing of the touch-based movement gesture, and displaying, on the touch screen, the updated number of banknotes of the first denomination and the updated number of banknotes of the second denomination along with the symbols corresponding to the plurality of denominations.

The method may further include checking a number of banknotes of the first denomination remaining and a number of banknotes of the second denomination remaining, in response to the sensing of the touch-based movement gesture.

The method may further include updating the number of banknotes of the first denomination and the number of banknotes of the second denomination when the number of banknotes of the first denomination remaining and the number of banknotes of the second denomination remaining are sufficient to satisfy a number of banknotes of the first denomination and a number of banknotes of the second denomination, required for an update through the touch-based gesture.

The method may further include refusing to update the number of banknotes of the first denomination and the number of banknotes of the second denomination when the number of banknotes of the first denomination remaining and the number of banknotes of the second denomination remaining are insufficient to satisfy a number of banknotes of the first denomination and a number of banknotes of the second denomination, required for an update through the touch-based gesture.

The method may further include computing the number of banknotes of each of the plurality of denominations based on a previously defined setting in response to the reception of the request.

The computing may include computing of the number of banknotes of each of the plurality of denominations that constitutes the withdrawal amount, based on a table that predetermines the number of banknotes of each denomination, in response to the reception of the request.

The computing may include computing the number of banknotes of each of the plurality of denominations that constitutes the withdrawal amount based on a setting of the user for the number of banknotes of each denomination, in response to the reception of the request.

The method may further include determining a number of banknotes of each of the plurality of denominations remaining, in response to the reception of the request for withdrawal, and displaying, on the touch screen based on the determination, a maximum number of banknotes of each of the plurality of denominations available.

The method may further include decreasing the number of banknotes of the first denomination every time a drag-and-drop event from the first denomination to the second denomination occurs, and computing an increase in the number of banknotes of the second denomination based on the reduction in the number of the banknotes of the first denomination, and the touch-based movement gesture includes a drag-and-drop event from the first denomination to the second denomination.

The updating may include updating the number of banknotes of the first denomination and the number of banknotes of the second denomination, based on the reduction in the number of the banknotes of the first denomination and the increase in the number of banknotes of the second denomination, as a result of the calculation.

The method may further include selecting banknotes of the first denomination, and a number of the selected banknotes of the first denomination increases in proportion to a period of time of touching the symbol corresponding to the first denomination on the touch screen.

The method may further include displaying a warning window informing the user that a number of banknotes of the second denomination remaining is insufficient when the number of banknotes of the second denomination remaining is insufficient to be substituted with respect to the reduction in the number of the banknotes of the first denomination.

The method may further include displaying an inquiry window to inquire, with the user, as to whether to substitute a third denomination when a number of banknotes of the second denomination remaining is insufficient to be substituted with respect to the reduction in the number of the banknotes of the first denomination, and the plurality of denominations further includes the third denomination in addition to the first denomination and the second denomination.

The method may further include computing a number of banknotes of a third denomination corresponding to a number of banknotes of the second denomination additionally required when a number of banknotes of the second denomination remaining is insufficient to be substituted with respect to the reduction in the number of the banknotes of the first denomination, and the plurality of denominations further includes the third denomination in addition to the first denomination and the second denomination.

According to another aspect of the present invention, there is provided an apparatus for selecting denominations in an automated teller machine (ATM), the apparatus including a receiving unit to receive a request for withdrawal from a user, a displaying unit to display, on a touch screen, symbols corresponding to a plurality of denominations including a first denomination and a second denomination that constitutes a withdrawal amount of the user, and a number of banknotes of each of the plurality of denominations, in response to the reception of the request, a sensing unit to sense a touch-based movement gesture from the first denomination to the second denomination, an updating unit to update a number of banknotes of the first denomination and a number of banknotes of the second denomination, in response to the sensing of the touch-based movement gesture, and a displaying unit to display, on the touch screen, the updated number of banknotes of the first denomination and the updated number of banknotes of the second denomination along with the symbols corresponding to the plurality of denominations.

The apparatus may further include a checking unit to check a number of banknotes of the first denomination remaining and a number of banknotes of the second denomination remaining, in response to the sensing of the touch-based movement gesture.

The apparatus may further include a determining unit to determine whether the number of banknotes of the first denomination remaining and the number of banknotes of the second denomination remaining are sufficient to satisfy a number of banknotes of the first denomination and a number of banknotes of the second denomination, required for an update through the touch-based gesture, and the updating unit may update the number of banknotes of the first denomination and the number of banknotes of the second denomination.

The apparatus may further include a database (DB) to store a table in which the number of banknotes of each of the plurality of denominations constitutes the withdrawal amount is defined in advance, and a computing unit to compute the number of banknotes of each of the plurality of denominations that constitutes the withdrawal amount, based on the table, in response to the reception of the request.

The touch-based movement gesture may include a drag-and-drop event from the first denomination to the second denomination, and the computing unit may decrease the number of banknotes of the first denomination every time that a drag-and-drop event from the first denomination to the second denomination occurs, and may compute an increase in the number of banknotes of the second denomination based on the reduction in the number of the banknotes of the first denomination.

The plurality of denominations may further include the third denomination in addition to the first denomination and the second denomination, and the computing unit may compute a number of banknotes of a third denomination corresponding to a number of banknotes of the second denomination additionally required when a number of banknotes of the second denomination remaining is insufficient to be substituted with respect to the reduction in the number of the banknotes of the first denomination.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a flowchart illustrating a method of selecting denominations in an automated teller machine (ATM) according to an embodiment of the present invention;

FIG. 2 is a diagram illustrating a table, in which a number of banknotes for each of a plurality of denominations is defined in advance, and stored in a database (DB) according to an embodiment of the present invention;

FIG. 3 is a diagram illustrating a screen, on which symbols corresponding to a plurality of denominations and a number of banknotes of each of the denominations are displayed, of a denomination selecting apparatus in an ATM according to an embodiment of the present invention;

FIGS. 4A and 4B are flowcharts illustrating a method of selecting denominations in an ATM according to another embodiment of the present invention; and

FIG. 5 is a block diagram illustrating a denomination selecting apparatus in an ATM according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

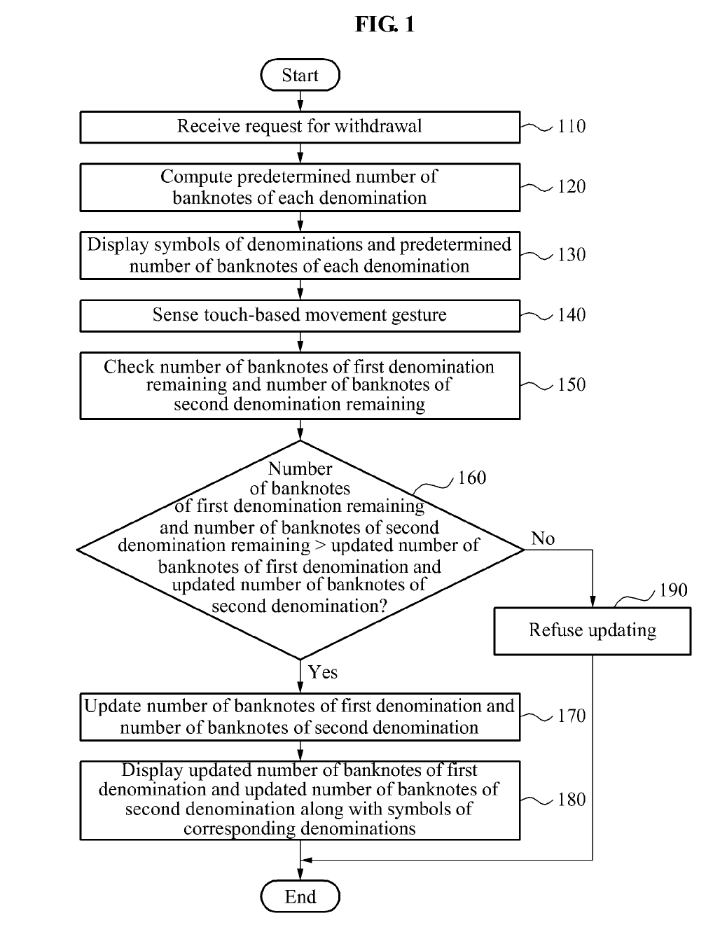

FIG. 1 illustrates a method of selecting denominations in an automated teller machine (ATM) according to an embodiment of the present invention.

When a user touches a symbol “withdrawal” on a menu displayed on a touch screen of the ATM, a request for withdrawal is received from the user in operation 110. In response to the reception of the request, a denomination selecting apparatus of the ATM may compute a number of banknotes of each of a plurality of denominations based on a predetermined setting in operation 120.

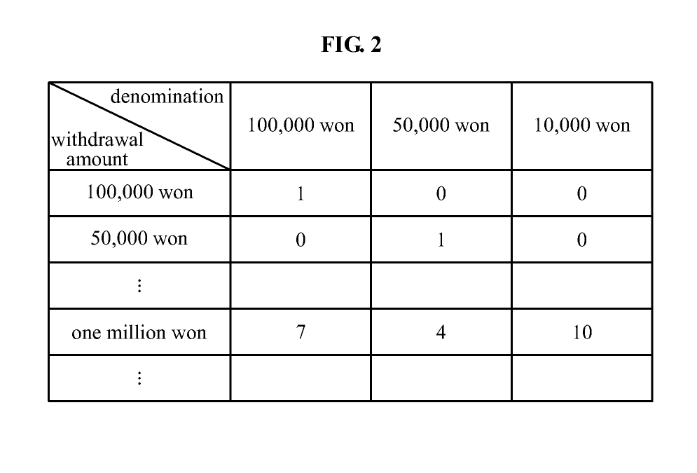

In response to the received request, the denomination selecting apparatus may compute the number of banknotes of each of the denominations, based on a table, in operation 120. Here, the table, in which a number of banknotes of each of denominations constituting a withdrawal amount is determined in advance, may be stored in a database (DB). For example, the table may be embodied as shown in FIG. 2.

Also, in response to the received request, the denomination selecting apparatus may refer to a setting of the user for the number of banknotes of each of the denominations constituting the withdrawal amount. In this example, the user may previously set the number of banknotes of each of the denominations or preferred denominations and the like, or may set the number of banknotes of each of the denominations by answering a question in a window additionally displayed on the touch screen.

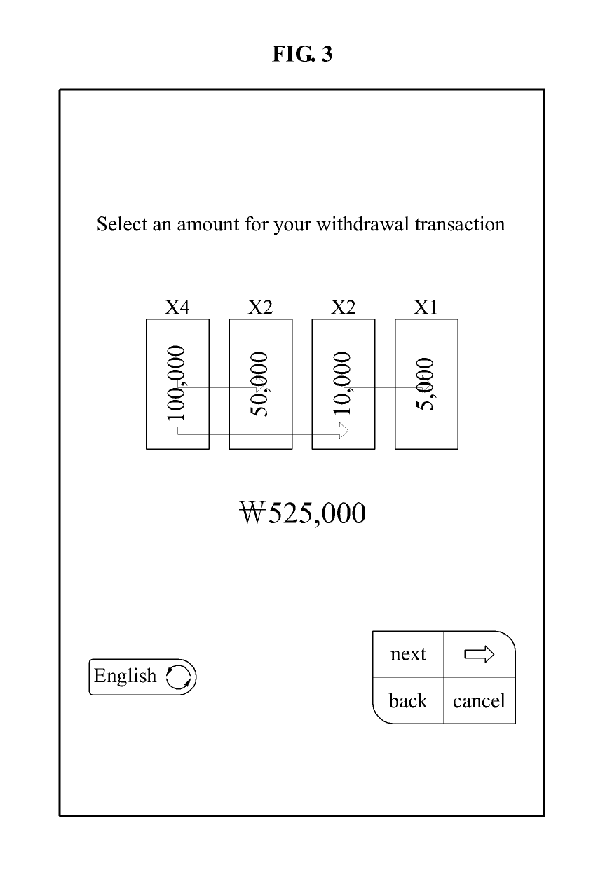

In response to the received request, the denomination selecting apparatus may display, on the touch screen, symbols corresponding to the plurality of denominations including a first denomination and a second denomination constituting the withdrawal amount, and the number of banknotes of each of the plurality of denominations in operation 130. The screen on which the symbols corresponding to the plurality of denominations and the number of banknotes of each of the denominations are displayed may be shown in FIG. 3.

Hereinafter, the first denomination, the second denomination, and the like may be Korean Won, for example, a 10,000 won bill, a 50,000 won bill, 100,000 won bill, and the like, and may include varied banknotes of various countries, for example, U.S. dollars, Japanese Yen, Chinese Yuan, and the like.

The denomination selecting apparatus may check a number of banknotes of each of the denominations remaining, and may display, on the touch screen, a maximum number of banknotes of each of the denominations available, based on a result of the check, in response to the received request. In this example, an operation of displaying the maximum number of banknotes may be performed before or after operation 130, only when operation 110 is completed.

The denomination selecting apparatus may sense a touch-based movement gesture from the first denomination to the second denomination in operation 140. Here, the touch-based gesture may be, for example, an operation of drag-and-drop from a symbol of the 50,000 won bill to a symbol of the 10,000 won bill displayed on the touch screen, using a finger. The denomination selecting apparatus may check a number of banknotes of the first denomination remaining and a number of banknotes of the second denomination remaining in operation 150 in response to the received request. In this example, whether the withdrawal amount is able to be withdrawn in denominations desired by the user may be determined by checking of the number of banknotes of each of the denominations.

In operation 160, the denomination selecting apparatus may determine whether the number of banknotes of the first denomination remaining and the number of banknotes of the second denomination remaining are sufficient to satisfy a number of banknotes of the first denomination and a number of banknotes of the second denomination, required for an update through the touch-based movement gesture. In operation 170, the denomination selecting apparatus may update the number of banknotes of the first denomination and the number of banknotes of the second denomination in response to the sensing of the touch-based movement gesture when the number of banknotes of the first denomination remaining and the number of banknotes of the second denomination remaining are greater the number of banknotes of the first denomination and the number of banknotes of the second denomination, required for an update through the touch-based movement gesture.

In operation 180, the denomination selecting apparatus may display, on the touch screen, the updated number of banknotes of the first denomination and the updated number of banknotes of the second denomination along with symbols corresponding to the denominations.

Conversely, when the number of banknotes of the first denomination remaining and the number of banknotes of the second denomination remaining are insufficient to satisfy the number of banknotes of the first denomination and the number of banknotes of the second denomination, required for an update through the touch-based movement gesture, as a result of the determination in operation 160, the denomination selecting apparatus may refuse to update the number of banknotes of the first denomination and the number of banknotes of the second denomination, and may terminate an operation in operation 190.

FIG. 2 illustrates a table, in which a number of banknotes for each of a plurality of denominations is defined in advance, and stored in a DB according to an embodiment of the present invention.

The table stored in the DB may correspond to a table including a combination of denominations for each withdrawal amount to be withdrawn by a user. Accordingly, when it is assumed that the withdrawal amount to be withdrawn in response to a request for withdrawal of the user is one million won, a denomination selecting apparatus may compute, based on the table, a combination of denominations for one million won as seven 100,000 won bills, four 50,000 won bills, and ten 10,000 won bills.

The table of FIG. 2 is merely an example, and the table may be configured to include varied combinations of denominations for each withdrawal amount.

FIG. 3 illustrates a screen, on which symbols corresponding to a plurality of denominations and a number of banknotes of each of the denominations are displayed, of a denomination selecting apparatus in an ATM according to an embodiment of the present invention.

The ATM may display, on a touch screen, an image to be used for selecting a financial transaction including a withdrawal transaction, a deposit transaction, a remittance transaction, and the like. Accordingly, when the user selects the withdrawal transaction, the denomination selecting apparatus may provide a screen as illustrated in FIG. 3.

First, a phrase “select an amount for your withdrawal transaction” may be displayed on the touch screen of the ATM. In this example, when the user inputs a withdrawal amount, a number of banknotes of each of denominations computed based on the table stored in the DB and symbols of the denominations may be displayed.

For example, when the withdrawal amount input by the user is 525,000 won, and the number of each of the denominations is four 100,000 won bills, two 50,000 won bills, two 10,000 won bills, and one 5,000 won bill.

Accordingly, 4, 2, 2, and 1 may be displayed on locations adjacent to corresponding denominations displayed on the touch screen, respectively.

In this example, when the user merely wants three 100,000 won bills, and four 50,000 won bills among the denominations of the withdrawal amount, the user may make a touch-based movement gesture through a drag-and-drop event from a 100,000 won bill to a 50,000 won bill using a finger.

The denomination selecting apparatus may sense the touch-based movement gesture of the user, and may update a number of 100,000 won bills and a number of 50,000 won bills to 3 and 4, respectively. The updated number of banknotes of each of the denominations may be displayed on the touch screen along with symbols of corresponding denominations. In this example, the number of each of the denominations may be displayed on locations adjacent to the symbols of the denominations, that is to a top, bottom, left, and right of the symbols. Accordingly, 3 may be displayed on a location adjacent to 100,000 won bill, and 4 may be displayed on a location adjacent to 50,000 won bill.

However, when a number of banknotes of a denomination desired by the user, for example, a 50,000 won bill, is insufficient, the denomination selecting apparatus may display a warning window reporting that the updating is not able to be performed, and may refuse the updating. In addition, the denomination selecting apparatus may inquire, with the user, as to whether to substitute another denomination, for example, a 10,000 won bill, for a denomination of which a number of banknotes is insufficient, for example, a 50,000 won bill, as many banknotes as needed to resolve insufficiency occurring in the number of banknotes of the denomination, and may provide the withdrawal amount including banknotes of the substituted denomination.

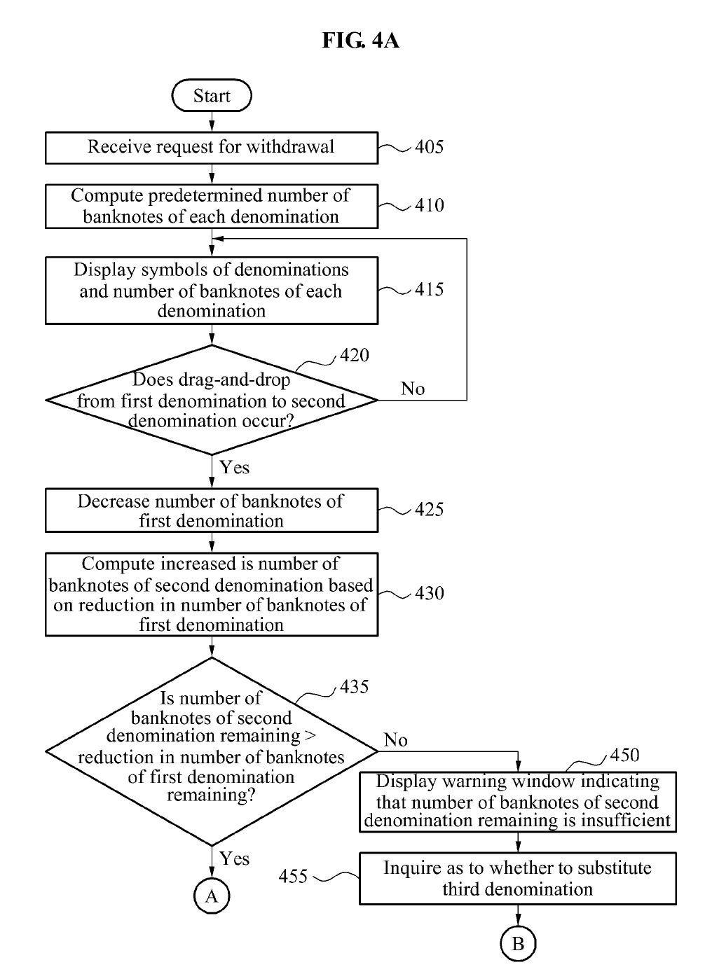

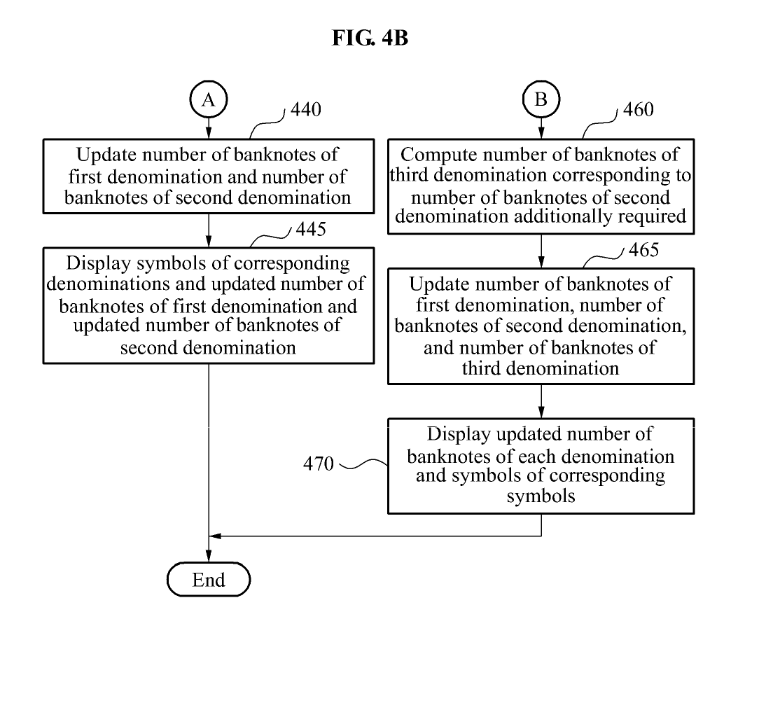

FIGS. 4A and 4B are flowcharts illustrating a method of selecting denominations in an ATM according to another embodiment of the present invention

When a request for withdrawal is received from a user by the user touching a withdrawal menu in a menu displayed on a touch screen of the ATM in operation 405, a denomination selecting apparatus of the ATM may compute, based on a predetermined setting, a number of banknotes of each of a plurality of denominations, in response to the received request in operation 410.

The denomination selecting apparatus may refer to a table that predetermines a number of banknotes of each of denominations constituting a withdrawal amount of the user, or may refer to a setting of the user for a number of banknotes of each of the denominations constituting the withdrawal amount.

In operation 415, the denomination selecting apparatus may display, on the touch screen, the number of banknotes of each of the denominations along with symbols corresponding to the denominations including a first denomination and a second denomination constituting the withdrawal amount of the user.

Subsequently, when a drag-and-drop from the first denomination to the second denomination is performed by the user on the touch screen in operation 420, the user may decrease a number of the first denomination every time that a drag-and-drop event from the first denomination to the second denomination occurs in operation 425. The denomination selecting apparatus may compute an increase in the number of banknotes of the second denomination, based on the reduction in the number of banknotes of the first denomination, in operation 430. The increase in the number of banknotes of the first denomination and the reduction in the number of banknotes of the second denomination occurring every time that a drag-and-drop event occurs may be displayed on the touch screen. The ATM may allocate, to a corresponding denomination cassette, a number of banknotes required based on a result of the computation, so as to provide the withdrawal amount to the user.

In advance of performing operations 425 and 430, the denomination selecting apparatus may determine a number of banknotes in each denomination cassette, and may display, on the touch screen, a maximum number of banknotes of each of denominations available based on a result of the determination.

In operation 435, the denomination selecting apparatus may determine whether a number of banknotes of the second denomination remaining is sufficient to be substituted with respect to the reduction in the number of banknotes of the first denomination in operation 435.

When the number of banknotes of the second denomination remaining is sufficient to be substituted with respect to the reduction in the number of banknotes of the first denomination, the denomination selecting apparatus may update the number of banknotes of the first denomination and the number of banknotes of the second denomination based on a result of the calculation in operation 440. When the updating is performed, the denomination selecting apparatus may take into account a reduction in the number of banknotes of the first denomination, an increase in the number of banknotes of the second denomination, and an increase to be made in the number of banknotes of the second denomination in proportion to a reduction in the number of the banknotes of the first denomination. The updated number of banknotes of the first denomination and the updated number of banknotes of the second denomination may be displayed on the touch screen of the ATM along with symbols of the first denomination and the second denomination in operation 445.

The denomination selecting apparatus may select banknotes of the first denomination, and a number of the selected banknotes of the first denomination may increase in proportion to a period of time of touching the symbol corresponding to the first denomination on the touch screen.

For example, the denomination selecting apparatus may select one banknote of the first denomination by touching the symbol corresponding to the first denomination for one second, and may select five banknotes of the first denomination by touching the symbol for five seconds.

When the number of banknotes of the second denomination remaining is insufficient to be substituted with respect to the reduction in the number of the banknotes of the first denomination, the denomination selecting apparatus may display a warning window informing the user that the number of banknotes of the second denomination remaining is insufficient in operation 450.

The denomination selecting apparatus may display an inquiry window to inquire, with the user, as to whether to substitute a third denomination when the number of banknotes of the second denomination remaining is insufficient to be substituted with respect to the reduction in the number of banknotes of the first denomination in operation 455. In this example, when the user selects to substitute the third denomination, the denomination selecting apparatus may compute a number of banknotes of the third denomination corresponding to a number of banknotes of the second denomination additionally required in operation 460. Here, the plurality of denominations may include the third denomination in addition to the first denomination and the second denomination constituting the withdrawal amount of the user.

The denomination selecting apparatus may update, based on a result of the computation, the number of banknotes of the first denomination, the number of banknotes of the second denomination, and the number of banknotes of the third denomination in operation 465, and may display the updated number of banknotes of each of the denominations along with symbols of the denominations.

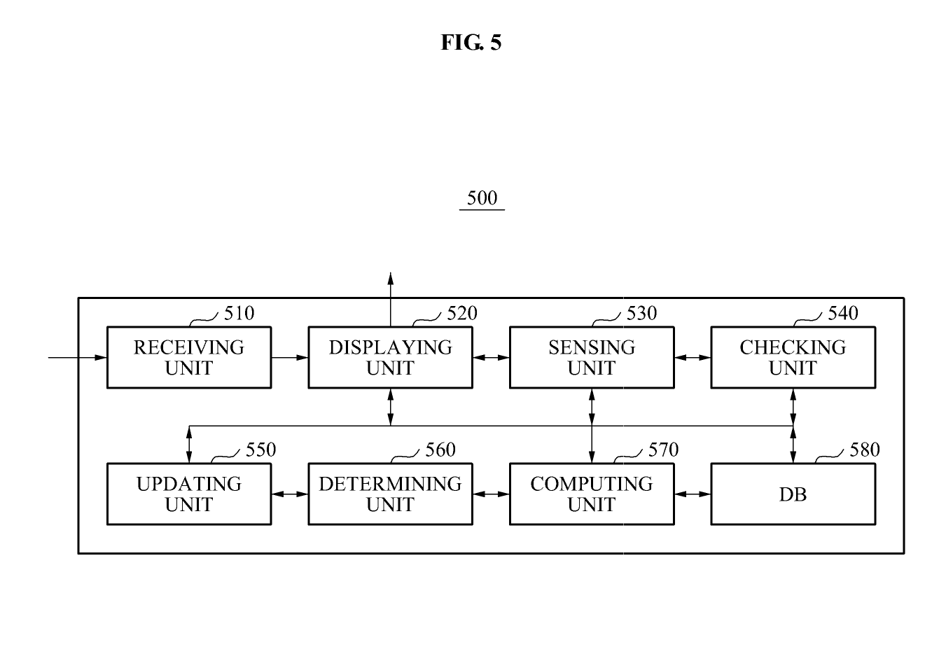

FIG. 5 illustrates a denomination selecting apparatus 500 in an ATM according to an embodiment of the present invention.

The denomination selecting apparatus 500 may include a receiving unit 510, a display unit 520, a sensing unit 530, and an updating unit 550. The denomination selecting apparatus 500 may further include a checking unit 540, a determining unit 560, a computing unit 570, and a DB 580.

The receiving unit 510 may receive a request for withdrawal of a user.

The display unit 520 may display, on a touch screen, symbols corresponding to a plurality of denominations including a first denomination and a second denomination constituting a withdrawal amount of the user, along with a number of banknotes of each of the denominations. The plurality of denominations may further include a third denomination in addition to the first denomination and the second denomination constituting the withdrawal amount of the user.

The sensing unit 530 may sense a touch-based movement gesture from the first denomination to the second denomination. Here, the touch-based movement gesture may include an operation of a drag-and-drop from a symbol of the first denomination to a symbol of the second denomination displayed on the touch screen, using a finger or varied tools.

The updating unit 550 may update a number of banknotes of the first denomination and a number of banknotes of the second denomination in response to sensing of the touch-based movement gesture. In this example, the display unit 520 may display, on the touch screen, the updated number of banknotes of the first denomination and the updated number of banknotes of the second denomination along with symbols corresponding to the plurality of denominations.

The checking unit 540 may check a number of banknotes of the first denomination remaining and a number of banknotes of the second denomination remaining, in response to the touch-based movement gesture.

The updating unit 550 may update the number of banknotes of the first denomination and the number of banknotes of the second denomination, based on a result of determination of the determining unit 560.

The determining unit 560 may determine whether the number of banknotes of the first denomination remaining and the number of banknotes of the second denomination remaining are sufficient to be substituted with respect to a number of banknotes of the first denomination and a number of banknotes of the second denomination, required for an update through the touch-based movement gesture.

The computing unit 570 may compute a number of banknotes of each of a plurality of denominations based on a table in which a number of banknotes of each of a plurality of denominations constituting a withdrawal amount of the user is determined in advance, stored in the DB 580.

The computing unit 570 may decrease the number of banknotes of the first denomination every time that a drag-and-drop event from the first denomination to the second denomination occurs and may compute an increase in the number of banknotes of the second denomination based on the reduction in the number of the banknotes of the first denomination.

In addition, the computing unit 570 may compute a number of banknotes of the third denomination corresponding to a number of banknotes of the second denomination additionally required, when the number of banknotes of the second denomination remaining is insufficient to be substituted with respect to the reduction in the number of banknotes of the first denomination.

The DB 580 may store the table in which a number of banknotes of each of a plurality of denominations constituting a withdrawal amount of the user is determined in advance.

Embodiments of the present invention may provide a method and apparatus for sensing a touch-based movement gesture among a plurality of denominations displayed to a user through a touch screen, and providing a withdrawal amount in a combination of banknotes of denominations desired by the user.

Embodiments of the present invention may provide a method and apparatus for substituting another denomination for a selected denomination when a number of banknotes of the selected denomination remaining is insufficient and thus, varied options may be provided when a number of banknotes of a desired denomination remaining is insufficient.

Additional aspects, features, and/or advantages of the invention will be set forth in part in the description which follows and, in part, will be apparent from the description, or may be learned by practice of the invention.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of selecting denominations in an automated teller machine (ATM), the method comprising:
receiving a request for withdrawal from a user;
displaying, on a touch screen, symbols corresponding to a plurality of denominations including a first denomination and a second denomination that constitute a withdrawal amount of the user, and a number of banknotes of each of the plurality of denominations, in response to the reception of the request;
sensing a touch-based movement gesture from the first denomination to the second denomination;
updating a number of banknotes of the first denomination and a number of banknotes of the second denomination, in response to the sensing of the touch-based movement gesture; and
displaying, on the touch screen, the updated number of banknotes of the first denomination and the updated number of banknotes of the second denomination along with the symbols corresponding to the plurality of denominations.

2. The method of claim 1, further comprising:
checking a number of banknotes of the first denomination remaining and a number of banknotes of the second denomination remaining, in response to the sensing of the touch-based movement gesture.

3. The method of claim 2, further comprising:
updating the number of banknotes of the first denomination and the number of banknotes of the second denomination when the number of banknotes of the first denomination remaining and the number of banknotes of the second denomination remaining are sufficient to satisfy a number of banknotes of the first denomination and a number of banknotes of the second denomination, required for an update through the touch-based gesture.

4. The method of claim 2, further comprising:
refusing to update the number of banknotes of the first denomination and the number of banknotes of the second denomination when the number of banknotes of the first denomination remaining and the number of banknotes of the second denomination remaining are insufficient to satisfy a number of banknotes of the first denomination and a number of banknotes of the second denomination, required for an update through the touch-based gesture.

5. The method of claim 1, further comprising:
computing the number of banknotes of each of the plurality of denominations that constitute the withdrawal amount, based on a table that predetermines the number of banknotes of each denomination, in response to the reception of the request.

6. The method of claim 1, further comprising:
computing the number of banknotes of each of the plurality of denominations that constitute the withdrawal amount based on a setting of the user for the number of banknotes of each denomination, in response to the reception of the request.

7. The method of claim 1, further comprising:
determining a number of banknotes of each of the plurality of denominations remaining, in response to the reception of the request for withdrawal; and
displaying, on the touch screen based on the determination, a maximum number of banknotes of each of the plurality of denominations available.

8. The method of claim 1, further comprising:
decreasing the number of banknotes of the first denomination every time that a drag-and-drop event from the first denomination to the second denomination occurs, and computing an increase in the number of banknotes of the second denomination based on the reduction in the number of the banknotes of the first denomination,
wherein the touch-based movement gesture includes a drag-and-drop event from the first denomination to the second denomination.

9. The method of claim 8, wherein the updating comprises:
updating the number of banknotes of the first denomination and the number of banknotes of the second denomination, based on the reduction in the number of the banknotes of the first denomination and the increase in the number of banknotes of the second denomination as a result of the calculation.

10. The method of claim 8, further comprising:
selecting banknotes of the first denomination, and a number of the selected banknotes of the first denomination increases in proportion to a period of time of touching the symbol corresponding to the first denomination on the touch screen.

11. The method of claim 8, further comprising:
displaying a warning window informing the user that a number of banknotes of the second denomination remaining is insufficient when the number of banknotes of the second denomination remaining is insufficient to be substituted with respect to the reduction in the number of the banknotes of the first denomination.

12. The method of claim 8, further comprising:
displaying an inquiry window to inquire with the user as to whether to substitute a third denomination when a number of banknotes of the second denomination remaining is insufficient to be substituted with respect to the reduction in the number of the banknotes of the first denomination,
wherein the plurality of denominations further includes the third denomination in addition to the first denomination and the second denomination.

13. The method of claim 8, further comprising:
computing a number of banknotes of a third denomination corresponding to a number of banknotes of the second denomination additionally required when a number of banknotes of the second denomination remaining is insufficient to be substituted with respect to the reduction in the number of the banknotes of the first denomination,
wherein the plurality of denominations further includes the third denomination in addition to the first denomination and the second denomination.
